(19) United States
(12) Patent Application Publication
(10) Pub. No.: US 2017/0210765 A1
(43) Pub. Date: Jul. 27, 2017

(54) PROCESS FOR PREPARING ALPHA-SILYLAMINE COMPOUNDS FROM ALPHA-SILYLMETHYL AZIDE COMPOUNDS

(71) Applicant: POSTECH ACADEMY-INDUSTRY FOUNDATION, Pohang (KR)

(72) Inventors: Jaiwook PARK, Pohang (KR); Jung Joon KIM, Pohang (KR); Wook JEONG, Ulsan (KR); Young Ho RHEE, Pohang (KR)

(21) Appl. No.: 15/327,064

(22) PCT Filed: Jan. 10, 2015
(86) PCT No.: PCT/KR2015/010352

§ 371 Date: Jan. 18, 2017

(30) Foreign Application Priority Data
Oct. 1, 2014 (KR) 10-2014-0132366

(51) Int. Cl. C07F 7/08; B01J 35/00; B01J 19/12; B01J 31/22

(52) U.S. Cl. CPC C07F 7/083; B01J 31/2295; B01J 35/004; B01J 19/127; B01J 2231/40; B01J 2531/821; B01J 2219/1203; B01J 2219/0892

(57) ABSTRACT

The present invention relates to a process for preparing alpha-silylamine compounds and, more specifically, to a one-pot process for preparing various alpha-silylamine compounds by reacting, in the presence of a metal complex catalyst and under a mild condition, an alpha-silylmethyl azide compound as a starting material with various allylborate compounds via an alpha-silylimine intermediate which has no substituent at nitrogen.

### TECHNICAL FIELD

The present invention relates to a method of preparing α-silylamine compounds, and more particularly, to a one-pot method of preparing various α-silylamine compounds from an α-silylmethyl azide compound as a starting material via an α-silylimine intermediate having no substituent on nitrogen through a reaction with various allylborate compounds under a mild condition in the presence of a metal complex catalyst.

### BACKGROUND ART

Densely functionalized complex amine compounds are an important structural element in synthetic organic chemistry due to their unique biochemical activity. In particular, much attention is drawn to highly substituted α-silylamines due to their structural specificity and biochemical function as in amino acid mimics. Moreover, a silyl group may be used as a useful precursor to be easily changed to an intermediate which is important in various reactions (see below).

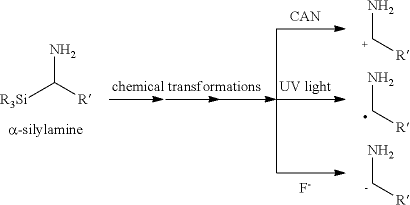

As shown in the above reaction formula, an α-silylamine may be changed to an iminium ion under an oxidant condition such as ceric ammonium nitrate (CAN). In addition, it may form an aminyl radical under a photocatalyst condition by irradiating UV or using a metal catalyst. Further, the α-silylamine may produce an anion capable of reacting with an electrophile such as carbon dioxide through a reaction with a fluoride ion activator. At the same time, the α-silylamine is stable in a neutral condition, and may be continuously maintained without being affected during a long synthesis process.

Recently, a lot of interest is shown in developing a conceptually new divergent synthesis strategy having optimal chemical efficiency while being capable of synthesizing three-dimensionally various heterocyclic compounds, based on a metal catalyst. Recently, utilization of a stereodefined N,O-acetal as a diversity-generating element which produces a divergence for divergent synthesis of cyclic compounds containing a nitrogen atom has been reported. From the viewpoint of chemical reactivity, the N,O-acetal may be utilized as a precursor of an iminium ion. Considering the chameleon-like reactivity and the above-described stability of α-silylamine, the α-silylamine may be used as an element diversifying the structure of an amine compound during the latter half of the reaction.

The reactivity-driven strategy as such may open up a new possibility to a new divergent synthesis method. Considering the importance of an amine compound in the organic chemistry and medicinal chemistry fields, this synthesis strategy may be importantly utilized in both target-oriented synthesis and diversity-oriented synthesis. In spite of this potential importance, this reactivity-driven divergent synthesis strategy has not been discussed in the organic chemistry field, since highly substituted and stereochemically complicated α-silylamine was not able to be easily synthesized.

Actually, for the study of α-silylamines, only the structurally very simple compounds have been studied. Generally, the α-silylamine has been synthesized by the method of adding a silyl anion or the derivative thereof to an imine compound, as follows:

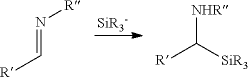

The scope of this reaction has a limitation on the imine compound having no enolizable hydrogen. Moreover, the conditions of the reaction forming a silyl anion are often significantly severe, and sometimes, several steps should be gone through.

The present inventors expected that a method of adding an alkyl anion via an N-unsubstituted α-silylimine would be more efficient and suitable, as compared with a conventional synthesis method, and carried out an experiment, and as a result, found out that when adding an allyl nucleophile to the α-silylimine, an α-silylamine compound having a plurality of substituents or stereocenters is prepared by chemical transformation to produce diastereoselectivity and enantioselectivity, thereby completing the present invention.

However, a method of preparing an α-silylamine by this method has rarely been studied. This is because there is a problem in a method of synthesizing an unsubstituted α-silylimine from the carbonyl precursor thereof.

### DISCLOSURE

### Technical Problem

An object of the present invention is to provide a one-pot method of preparing an α-silylamine compound by photoreacting an α-silylmethyl azide compound with an allylboronate or allenylboronate compound in the presence of a metal complex catalyst:

### Technical Solution

In one general aspect, a method of preparing an α-silylamine compound of the following Chemical Formula 1 includes: photoreacting an α-silylmethyl azide compound of the following Chemical Formula 2 with a boronate compound of the following Chemical Formula 3 in the presence of a metal complex catalyst:

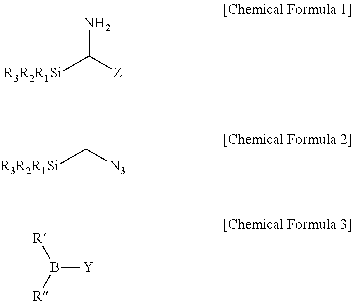

wherein R₁, R₂ and R₃ are independently of each other (C1-C20)alkyl;

when R′ and R″ are linked by

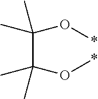 [SMILES: *OC(C)(C)C(C)(C)O*]

to form a ring, Y is

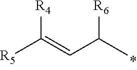

### and Z is

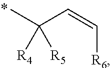

### or Y is

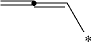

### and Z is

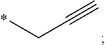

when R′ and R″ are

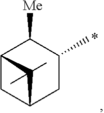

### Y is

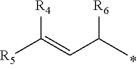

### and Z is

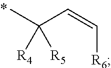

and

R₄, R₅ and R₆ are independently of each other hydrogen, (C1-C20)alkyl or (C6-C20)aryl.

In an exemplary embodiment of the present invention, a method of preparing an α-silylamine compound of the following Chemical Formula 1-a may include: photoreacting an α-silylmethyl azide compound of the following Chemical Formula 2 with an allylboronate compound of the following Chemical Formula 3-a in the presence of a metal complex catalyst:

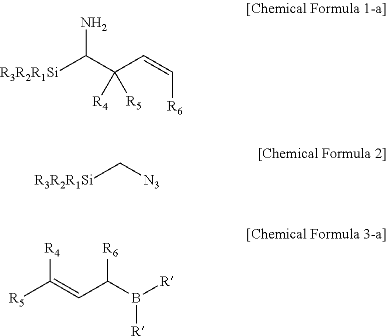

wherein R₁, R₂ and R₃ are independently of each other (C1-C20)alkyl;

R′ and R″ are

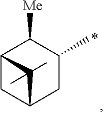

or R′ and R″ are linked by

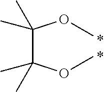

to form a ring; and

R₄, R₅ and R₆ are independently of each other hydrogen, (C1-C20)alkyl or (C6-C20)aryl.

In an exemplary embodiment of the present invention, a method of preparing an α-silylamine compound of the following Chemical Formula 1-b may include: photoreacting an α-silylmethyl azide compound of the following Chemical Formula 2 with an allenylboronate compound of the following Chemical Formula 3-b in the presence of a metal complex catalyst:

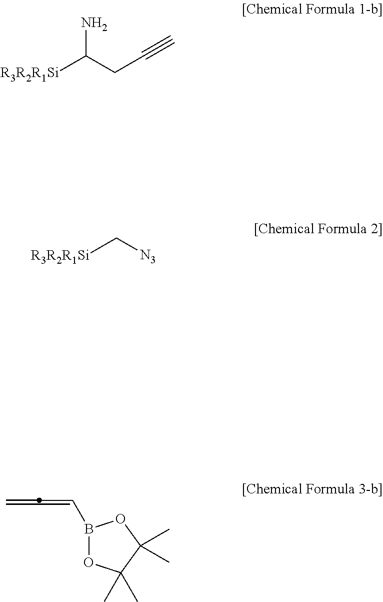

wherein R₁, R₂ and R₃ are independently of each other (C1-C20)alkyl.

In an exemplary embodiment of the present invention, the metal complex catalyst may be a ruthenium complex catalyst.

In an exemplary embodiment of the present invention, the ruthenium complex catalyst may be represented by the following structure:

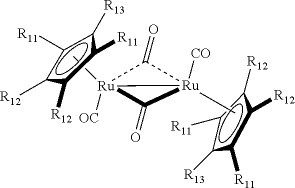

wherein R₁₁ and R₁₂ are independently of each other hydrogen, (C1-C20)alkyl or (C6-C20)aryl;

R₁₃ is NR₁₄R₁₅, OR₁₆, C(═O)NR₁₇R₁₈ or C(═O)OR₁₉;

R₁₄ to R₁₉ are independently of each other hydrogen, (C1-C20)alkyl or (C6-C20)aryl.

In an exemplary embodiment of the present invention, the ruthenium complex catalyst may be represented by the following structure:

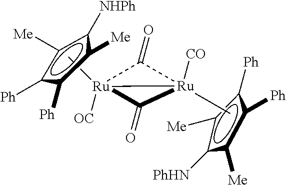

In an exemplary embodiment of the present invention, the photoreaction may be carried out under irradiation of visible light.

In an exemplary embodiment of the present invention, the boronate compound of the above Chemical Formula 3 may be selected from the boronate compounds represented by the following Chemical Formulae 4 to 6:

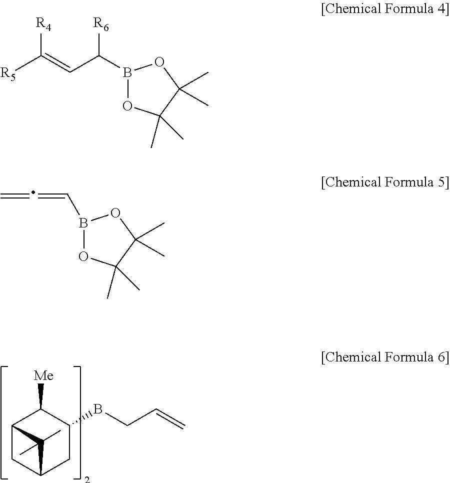

wherein R₄, R₅ and R₆ are independently of each other hydrogen, (C1-C20)alkyl or (C6-C20)aryl.

In an exemplary embodiment of the present invention, when the boronate compound of the above Chemical Formula 4 or 5 is used, the photoreaction may be carried out at room temperature to 50° C.

In an exemplary embodiment of the present invention, when the boronate compound of the above Chemical Formula 6 is used, tri(C1-C10)alkyl borane may be further added.

In an exemplary embodiment of the present invention, a mixture of a silylmethyl azide compound of Chemical Formula 2 and tri(C1-C10)alkyl borane may be irradiated with visible light at room temperature to 50° C. in the presence of the ruthenium catalyst, and then the boronate compound of Chemical Formula 6 may be added at −78° C. to room temperature.

### Advantageous Effects

The method of preparing an α-silylamine compound of the present invention may produce various α-silylamine compounds from an α-silylmethyl azide compound via a nitrogen-unsubstituted α-silylimine intermediate through a reaction with various allylboronate compounds under a mild condition in the presence of a metal complex catalyst.

In addition, in the preparation method of the present invention, an α-silylamine compound having functional groups and multiple stereocenters including high diastereoselectivity and enantioselectivity, and a geometry of double bond, which was not able to be produced in the past, may be prepared by a one-pot reaction, through an addition reaction of an allyl nucleophile of an allylboronate compound.

In addition, the α-silylamine compound prepared by the preparation method of the present invention may be used in iminium ion-mediated oxidative cyclization under an oxidant condition such as ceric ammonium nitrate (CAN) by utilizing a silyl group.

### BEST MODE

As a result of conducting a study in order to develop a method of efficiently preparing an α-silylamine compound, the present inventors have developed a method of preparing an α-silylamine compound having substituents and multiple stereocenters including high diastereoselectivity and enantioselectivity, and a geometry of double bond, which was not able to be produced in the past, by photoreacting an α-silylmethyl azide compound with an allylboronate or allenylboronate compound in the presence of a metal complex catalyst.

The present invention provides a method of preparing an α-silylamine compound of the following Chemical Formula 1 by photoreacting an α-silylmethyl azide compound of the following Chemical Formula 2 with a boronate compound of the following Chemical Formula 3 in the presence of a metal complex catalyst:

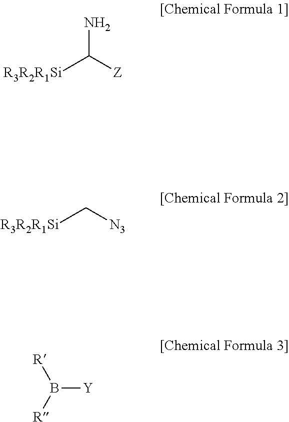

wherein R₁, R₂ and R₃ are independently of each other (C1-C20)alkyl;

when R′ and R″ are linked by

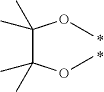

to form a ring, Y is

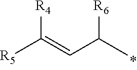

### and Z is

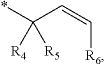

### or Y is

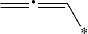 [SMILES: *C=C=C]

### and Z is

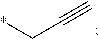 [SMILES: *CC#C]

when R′ and R″ are

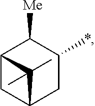

### Y is

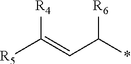

### and Z is

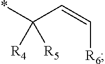

and

R₄, R₅ and R₆ are independently of each other hydrogen, (C1-C20)alkyl or (C6-C20)aryl.

The preparation method of the present invention includes photoreact ing an α-silylmethyl azide compound of the following Chemical Formula 2 with an allylboronate compound of the following Chemical Formula 3-a in the presence of a metal complex catalyst, to prepare an α-silylamine compound of the following Chemical Formula 1-a:

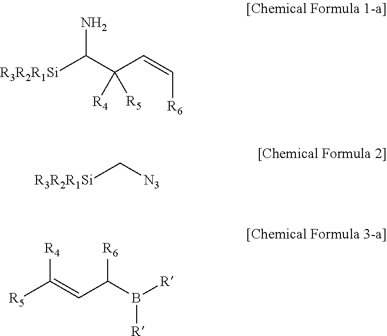

wherein R₁, R₂ and R₃ are independently of each other (C1-C20)alkyl;

R′ and R″ are

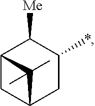

or R′ and R″ are linked by

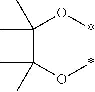 [SMILES: *OC(C)(C)C(C)(C)O*]

to form a ring; and

R₄, R₅ and R₆ are independently of each other hydrogen, (C1-C20)alkyl or (C6-C20)aryl.

In addition, the preparation method of the present invention includes photoreacting an α-silylmethyl azide compound of the following Chemical Formula 2 with an allenylboronate compound of the following Chemical Formula 3-b in the presence of a metal complex catalyst, to prepare an α-silylamine compound of the following Chemical Formula 1-b:

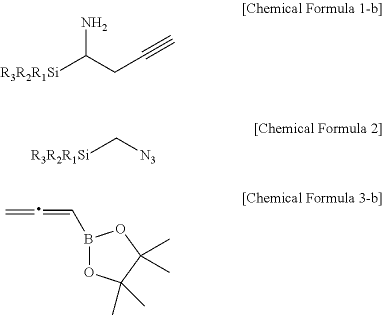

wherein R₁, R₂ and R₃ are independently of each other (C1-C20)alkyl.

The metal complex catalyst may be a ruthenium complex catalyst, but not limited thereto.

Preferably, the ruthenium complex catalyst is represented by the following structure:

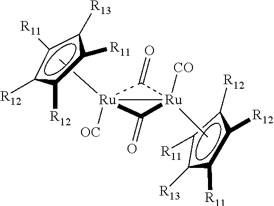

wherein R₁₁ and R₁₂ are independently of each other hydrogen, (C1-C20)alkyl or (C6-C20)aryl;

R₁₃ is NR₁₄R₁₅, OR₁₆, C(═O)NR₁₇R₁₈ or C(═O)OR₁₉;

R₁₄ to R₁₉ are independently of each other hydrogen, (C1-C20)alkyl or (C6-C20)aryl.

More preferably, the ruthenium complex catalyst is represented by the following structure:

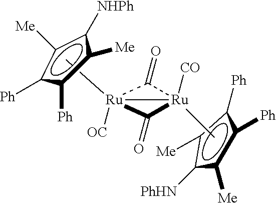

The reaction of the present invention is briefly shown in the following Reaction Formula 1:

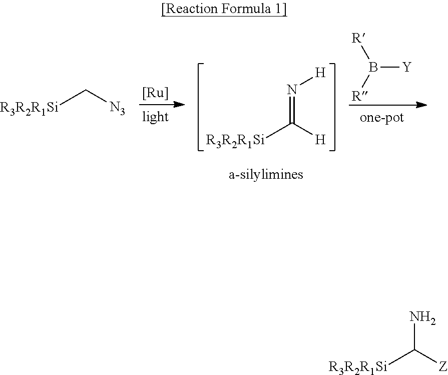

The photoreaction is carried out under irradiation of visible light, from which an imine intermediate having no substituent on nitrogen may be formed, and the formed α-silylimine intermediate having no substituent on nitrogen may be reacted with an allyl or allenyl nucleophile to prepare various α-silylamine compounds. Here, the irradiation of visible light may be carried out by using a 30 W household fluorescent light, as described in the Example of the present invention, and there is no limitation as long as visible light may be irradiated therefrom. The α-silylimine intermediate having no substituent on nitrogen may be formed at room temperature to 50° C. for an appropriate time under inert gas such as nitrogen.

The preparation of the α-silylamine compound by an addition reaction of the α-silylimine intermediate produced from an α-silylmethyl azide compound of Chemical Formula 2 with the boronate compound of Chemical Formula 3 may be carried out at −78° C. to room temperature under inert gas such as nitrogen gas.

The boronate compound of Chemical Formula 3 is an allyl or allenylboronate compound, and more preferably represented by the following Chemical Formulae 4 to 6:

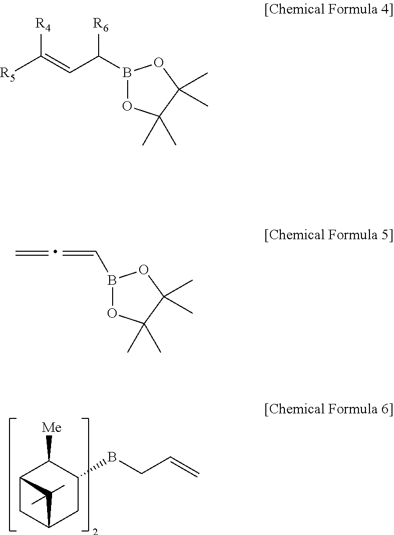

wherein R₄, R₅ and R₆ are independently of each other hydrogen, (C1-C20)alkyl or (C6-C20)aryl.

When the allyl or allenylboronate compound of Chemical Formula 4 or 5 is used, the formation of the α-silylimine intermediate having no substituent on nitrogen is carried out at room temperature to 50° C. for an appropriate time, and the preparation of the α-silylamine compound by the addition reaction of the produced α-silylimine intermediate with the allyl or allenylboronate compound of Chemical Formula 4 or 5 is carried out at room temperature for an appropriate time.

In addition, when the allylboronate compound of Chemical Formula 6 is used, tri(C1-C10)alkyl borane may be further added, and more preferably a mixture of the silylmethyl azide compound of Chemical Formula 2 and tri(C1-C10)alkyl borane may be irradiated with visible light at room temperature to 50° C. in the presence of the ruthenium catalyst, to form an α-silylimine intermediate having no substituent on nitrogen, and the boronate compound of Chemical Formula 6 may be added thereto at −78° C. to room temperature, more preferably −78° C., to prepare the α-silylamine compound.

An equivalent ratio of the α-silylmethyl azide compound of Chemical Formula 2 and the borate compound of Chemical Formula 3, used in the reaction may be varied, but preferably 1:1.1 to 2.0, and more preferably 1:1.5. An organic solvent used in the reaction may be tetrahydrofuran, toluene, benzene, ethyl acetate, etc., and preferably tetrahydrofuran is used. An amount of the metal complex catalyst used in the reaction is 1 to 3 mol %, but varied with the kinds of α-silylmethyl azide compound of Chemical Formula 2 to be used, and preferably 1.5 to 2 mol %.

The reaction for preparing the α-silylamine compound of the present invention is an addition reaction of an α-silylimine compound having no substituent on nitrogen formed from the α-silylmethyl azide with a borate compound, and includes a diastereoselective addition reaction and an asymmetric addition reaction depending on the structure of the borate compound.

Hereinafter, the constitution of the present invention is described in detail by the following Examples, but which are only for illuminating the present invention, and the scope of the present invention is not limited thereto.

### Examples 1 to 7: Addition Reaction Between Imine Having No Substituent on Nitrogen Produced from Silyl Azide Having α-Hydrogen and Allylborate Compound

In the present Examples, a ruthenium complex A of the following structure was used as a catalyst, to synthesize an α-silylimine intermediate having no substituent on nitrogen from silyl azide having α-hydrogen, and at the same time to carry out a continuous addition reaction of an allylborate compound, thereby preparing an α-silylamine compound.

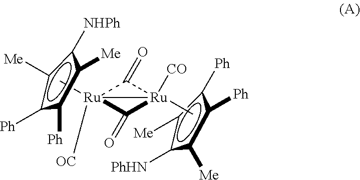

### [Example 1] Preparation of α-Silylamine Compound 1

A ruthenium catalyst A (5.1 mg, 0.005 mmol) was added to THF (0.25 mL) under the nitrogen atmosphere and stirred for 10 minutes to dissolve the ruthenium catalyst A. A solution of trimethylsilylmethyl azide (32.3 mg, 0.25 mmol) and allylboronic acid pinacol ester (68.2 μL, 0.375 mmol) dissolved in THF (0.25 mL) was added to the catalyst solution. The reaction mixture was stirred at room temperature for 3 hours under irradiation of a 30 W fluorescent light. When stirring was completed, chloroform (1 mL) was added thereto to finish the reaction, and stirring was carried out for another 5 minutes. Then, the reactant was transferred to a separatory funnel, and acidified with 1N HCl until the pH was 1, and an aqueous layer was separated therefrom. Then, the aqueous layer was neutralized with 6 N NaOH at 0° C. until the pH was 10. The aqueous layer was extracted with diethyl ether (5×5 mL), and then water was removed by Na₂SO₄ from the collected organic layer, which was concentrated under a reduced pressure condition after filtration.

The concentrated solution was directly dissolved in dichloromethane (CH₂Cl₂, 5 mL, 0.05 M) without a further purification process, and triethylamine (70 μL, 0.50 mmol) and p-toluenesulfonyl chloride (71.5 mg, 0.375 mmol) were added thereto. The reaction mixture was stirred for 12 hours at room temperature. When stirring was completed, water (3 mL) was added thereto to finish the reaction, and then dichloromethane (3×3 mL) was added to perform extraction. Water was removed by Na₂SO₄ from collected organic layer, which was concentrated under a reduced pressure condition after filtration. Purification with column chromatography using silica gel (3 cm×13 cm, eluent—hexane:ethyl acetate=80:20) gave a solid α-silylamine compound 1 (61.7 mg, 0.208 mmol, 83% yield). R_{f}=0.56 (hexane:EtOAc=80:20). m.p. 109° C.

¹H NMR (300 MHz, CDCl₃): δ=0.00 (s, 9H), 2.01-2.24 (m, 2H), 2.42 (s, 3H), 2.89 (dt, J=9.6, 2.6 Hz, 1H), 4.31 (d, J=9.6 Hz, 1H), 4.77-4.88 (m, 1H), 4.93 (dt, J=10.2, 0.9 Hz, 1H), 5.53 (dddd, J=17.1, 10.1, 7.8, 6.9 Hz, 1H), 7.29 (d, J=8.1 Hz, 2H), 7.76 (d, J=8.1 Hz, 2H); ¹³C NMR (75 MHz, CDCl₃): δ=−2.7, 21.7, 36.1, 43.7, 118.3, 127.5, 129.7, 135.1, 138.6, 143.4; IR: (cm⁻¹) v 3273, 3071, 2958, 2893, 1640, 1597, 1496, 1321, 1252, 1162, 1094; HRMS (FAB+) calcd for C₁₄H₂₄NO₂SiS: 298.1297, found: 298.1299.

### [Example 2] Preparation of α-Silylamine Compound 2

A ruthenium catalyst A (35.6 mg, 0.035 mmol) was added to THF (1.75 mL) under the nitrogen atmosphere and stirred for 10 minutes to dissolve the ruthenium catalyst A. A solution of dimethylphenylsilylmethyl azide (334.8 mg, 1.75 mmol and allylboronic acid pinacol ester (0.48 mL, 0.375 mmol) dissolved in THF (1.75 mL) was added to the catalyst solution. The reaction mixture was stirred at room temperature for 3 hours under irradiation of a 30 W fluorescent light. When stirring was completed, chloroform (3 mL) was added thereto to finish the reaction, and stirring was carried out for another 5 minutes. Then, the reactant was transferred to a separatory funnel, and acidified with 1N HCl until the pH was 1, and an aqueous layer was separated therefrom. Then, the aqueous layer was neutralized with 6 N NaOH at 0° C. until the pH was 10. The aqueous layer was extracted with diethyl ether (5×5 mL), and water was removed by Na₂SO₄ from the collected organic layer, which was concentrated under a reduced pressure condition after filtration. Purification with preparative TLC (PTLC, 10 cm×15 cm, eluent—hexane: isopropylamine=95:5) gave an α-silylamine compound 2 (291.6 mg, 1.42 mmol, 81% yield). R_{f}=0.34 (CH₂Cl₂:MeOH=90:10).

¹H NMR (300 MHz, CDCl₃): δ=0.34 (s, 6H), 1.17 (br s, 2H), 1.85-2.03 (m, 1H), 2.30-2.48 (m, 2H), 4.95-5.12 (m, 2H), 5.56-5.81 (m, 1H), 7.30-7.44 (m, 3H), 7.52-7.63 (m, 2H); ¹³C-NMR (75 MHz, CDCl₃): δ=−5.3, −5.0, 38.7, 40.2, 117.1, 128.1, 129.4, 134.3, 137.2, 137.2; IR: (cm⁻¹) v 3370, 3070, 2957, 2900, 1637, 1428, 1248, 1114, 998; HRMS (ESI+) calcd for C₁₂H₂₀NSi: 206.1360, found: 206.1359.

### [Example 3] Preparation of α-Silylamine Compound 3

A ruthenium catalyst A (5.1 mg, 0.005 mmol) was added to THF (0.25 mL) under the nitrogen atmosphere and stirred for 10 minutes to dissolve the ruthenium catalyst A. A solution of methyldiphenylsilylmethyl azide (63.3 mg, 0.25 mmol and allylboronic acid pinacol ester (68.2 μL, 0.75 mmol) dissolved in THF (0.25 mL) was added to the catalyst solution. The reaction mixture was stirred at room temperature for 3 hours under irradiation of a 30 W fluorescent light. When stirring was completed, chloroform (1 mL) was added thereto to finish the reaction, and stirring was carried out for another 5 minutes. Then, the reactant was concentrated under a reduced pressure condition, dissolved in hexane (2 mL), transferred to a separatory funnel, and acidified with 1N HCl until the pH was 1, and an aqueous layer was separated therefrom. Then, the aqueous layer was neutralized with 6 N NaOH at 0° C. until the pH was 10. The aqueous layer was extracted with diethyl ether (5×5 mL), and water was removed by Na₂SO₄ from the collected organic layer, which was concentrated under a reduced pressure condition after filtration. Purification with preparative TLC (PTLC, 10 cm×15 cm, eluent—hexane: isopropylamine=95:5) gave an α-silylamine compound 3 (46.1 mg, 0.172 mmol, 69% yield). R_{f}=0.68 (CH₂Cl₂:MeOH=90:10).

¹H NMR (300 MHz, CDCl₃): δ=0.64 (s, 3H), 1.65 (br s, 2H), 2.04 (ddd, J=13.8, 11.3, 8.7 Hz, 1H), 2.44 (ddd, J=14.0, 5.4, 1.7 Hz, 1H), 2.85 (dd, J=11.3, 2.9 Hz, 1H), 5.02-5.12 (m, 2H), 5.74 (dddd, J=19.1, 14.0, 5.9, 5.7 Hz, 1H), 7.32-7.47 (m, 6H), 7.58-7.66 (m, 4H); ¹³C NMR (75 MHz, CDCl₃): δ=−6.3, 38.5, 39.2, 117.4, 128.2, 128.2, 129.7, 129.7, 135.1, 135.2, 135.3, 137.0; IR: (cm⁻¹) v 3355, 3069, 3049, 2998, 2974, 2921, 1823, 1637, 1487, 1305, 1252, 1191, 1113, 1029, 998; HRMS (FAB+) calcd for C₁₇H₂₂NSi: 268.1522, found: 268.1521.

### [Example 4] Preparation of α-Silylamine Compound 4

A solid α-silylamine compound (49.1 mg, 0.166 mmol, 67% yield) was obtained in the same manner as in Example 1, except that trimethylsilylmethyl azide (32.3 mg, 0.25 mmol), a ruthenium catalyst A (5.1 mg, 0.005 mmol), and allenylboronic acid pinacol ester (134 μL, 0.750 mmol) were stirred at 50° C. for 5 hours under irradiation of a 30 W fluorescent light. m.p. 104° C.

¹H NMR (300 MHz, CDCl₃): δ=0.04 (s, 9H), 1.94 (t, J=2.7 Hz, 1H), 2.17 (dt, J=17.1, 3.0 Hz, 1H), 2.32 (ddd, J=17.1, 6.6, 2.7 Hz, 1H), 2.42 (s, 3H), 2.87 (ddd, J=9.9, 6.6, 3.0 Hz, 1H), 4.77 (d, J=10.2 Hz, 1H), 7.28 (d, J=8.1 Hz, 2H), 7.78 (d, J=8.4 Hz, 2H); ¹³C NMR (75 MHz, CDCl₃): δ=−2.8, 21.1, 21.7, 41.9, 71.5, 81.4, 127.4, 129.8, 138.4, 143.6; IR: (cm⁻¹) v 3306, 3063, 2957, 2925, 2854, 1724, 1651, 1599, 1494, 1327, 1289, 1252, 1184, 1094; HRMS (FAB+) calcd for C₁₄H₂₂NO₂SiS: 296.1141, found: 296.1139.

### [Example 5] Preparation of α-Silylamine Compound 5

An α-silylamine compound 5 (40.9 mg, 0.201 mmol, 80% yield) was obtained in the same manner as in Example 2, except that dimethylphenylsilylmethyl azide (47.8 mg, 0.25 mmol), a ruthenium catalyst A (5.1 mg, 0.005 mmol), and allenylboronic acid pinacol ester (134 μL, 0.750 mmol) were stirred at 50° C. for 3 hours under irradiation of a 30 W fluorescent light. R_{f}=0.61 (CH₂Cl₂:MeOH=90:10).

¹H NMR (300 MHz, CDCl₃): δ=0.37 (s, 6H), 1.41 (br s, 2H), 2.00 (t, J=2.6 Hz, 1H), 2.16 (ddd, J=16.8, 9.9, 2.6 Hz, 1H), 2.40 (ddd, J=16.8, 3.9, 2.7 Hz, 1H), 2.53 (dd, J=9.9, 3.9 Hz, 1H), 7.36-7.44 (m, 3H), 7.53-7.62 (m, 2H); ¹³C NMR (75 MHz, CDCl₃): δ==−5.1, −5.1, 24.7, 40.4, 70.2, 83.3, 128.1, 129.6, 134.2, 136.5; IR: (cm⁻¹) v 3304, 3069, 2049, 2957, 2899, 1489, 1488, 1427, 1250, 1113, 998; HRMS (ESI+) calcd for C₁₂H₁₈NSi: 204.1203, found: 204.1203.

### [Example 6] Preparation of α-Silylamine Compound 6

An α-silylamine compound 6 (56.5 mg, 0.213 mmol, 85% yield) was obtained in the same manner as in Example 3, except that methyldiphenylsilylmethyl azide (63.3 mg, 0.25 mmol), a ruthenium catalyst A (5.1 mg, 0.005 mmol), and allenylboronic acid pinacol ester (134 μL, 0.750 mmol) were stirred at 50° C. for 3 hours under irradiation of a 30 W fluorescent light. R_{f}=0.76 (CH₂Cl₂:MeOH=90:10).

¹H NMR (300 MHz, CDCl₃): δ=0.65 (s, 3H), 1.57 (br s, 2H), 2.02 (t, J=2.7 Hz, 1H), 2.25 (ddd, J=16.8, 7.5, 2.5 Hz, 1H), 2.49 (ddd, J=16.8, 3.3, 2.8 Hz, 1H), 2.97 (dd, J=10.5, 3.6 Hz, 1H), 7.33-7.49 (m, 6H), 7.61-7.71 (m, 4H); ¹³C NMR (75 MHz, CDCl₃): δ=−6.3, 24.7, 39.4, 70.3, 83.2, 128.2, 129.9, 129.9, 134.6, 134.8, 135.1, 135.2; IR: (cm⁻¹) v 3364, 3293, 3069, 3048, 2957, 2922, 1489, 1487, 1428, 1253, 1191, 1113, 998; HRMS (ESI+) calcd for C₁₇H₂₀NSi: 266.1360, found: 266.1360.

### [Example 7] Preparation of α-Silylamine Compound 7

A solid α-silylamine compound 7 (56.4 mg, 0.173 mmol, 69% yield) was obtained in the same manner as in Example 1, except that trimethylsilylmethyl azide (32.3 mg, 0.25 mmol), a ruthenium catalyst A (5.1 mg, 0.005 mmol), and 3,3-dimethylallylboronic acid pinacol ester (83 μL, 0.375 mmol) were stirred at 50° C. for 5 hours under irradiation of a 30 W fluorescent light. R_{f}=0.49 (hexane:EtOAc=90:10). m.p. 153° C.

¹H NMR (500 MHz, CDCl₃): δ=0.02 (s, 9H), 0.88 (s, 3H), 0.94 (s, 3H), 2.40 (s, 3H), 2.95 (d, J=10.0 Hz, 1H), 4.25 (d, J=10.0 Hz, 1H), 4.93-5.21 (m, 2H), 5.68 (dd, J=17.5, 10.5 Hz, 1H), 7.26 (d, J=8.0 Hz, 2H), 7.72 (d, J=8.0 Hz, 2H); ¹³C NMR (125 MHz, CDCl₃): δ=0.1, 21.7, 25.5, 27.2, 41.8, 55.0, 112.9, 127.1, 129.6, 139.8, 143.0, 146.0; IR: (cm⁻¹) v 3302, 3081, 3062, 2967, 2933, 1639, 1598, 1497, 1380, 1252, 1155, 1094; HRMS (ESI+) calcd for C₁₆H₂₇NO₂SSiNa: 348.1424, found: 348.1425.

It was confirmed from the above Examples 1 to 7 that the α-silylamine compound was produced with a high yield by an addition reaction between imine having no substituent on nitrogen produced from silyl azide having α-hydrogen and an allylborate compound.

### Examples 8 to 14 Diastereoselective Addition Reaction Between Imine Having No Substituent on Nitrogen Produced from Silyl Azide Having α-Hydrogen and Allylborate Compound

In the present Examples, a ruthenium complex A was used as a catalyst, to synthesize an α-silylimine intermediate having no substituent on nitrogen from silyl azide having α-hydrogen, and at the same time to carry out a diastereoselective addition reaction of an allylborate compound, thereby preparing an α-silylamine compound.

### [Example 8] Preparation of α-Silylamine Compound 8

A solid α-silylamine compound 8 (77.6 mg, 0.249 mmol, 83% yield) was obtained in the same manner as in Example 1, except that trimethylsilylmethyl azide (38.8 mg, 0.30 mmol), a ruthenium catalyst A (6.1 mg, 0.006 mmol), and cis-crotylboronic acid pinacol ester (81.9 mg, 0.45 mmol) were stirred at room temperature for 5 hours under irradiation of a 30 W fluorescent light. R_{f}=0.24 (hexane:EtOAc=90:10). m.p. 129° C.

¹H NMR (300 MHz, CDCl₃): δ=0.01 (s, 9H), 0.90 (d, J=7.2 Hz, 3H), 2.18-2.30 (m, 1H), 2.41 (s, 3H), 2.86 (dd, J=9.9, 4.2 Hz, 1H), 4.35-4.51 (m, 1H), 4.73-4.92 (m, 2H), 5.55 (ddd, J=17.1, 10.2, 8.7 Hz, 1H), 7.28 (d, J=8.1 Hz, 2H), 7.75 (d, J=8.4 Hz, 2H); ¹³C NMR (75 MHz, CDCl₃): δ=−1.2, 17.9, 21.7, 41.8, 49.6, 115.4, 127.3, 129.7, 138.9, 141.7, 143.3; IR: (cm⁻¹) v 3281, 2961, 2851, 1597, 1496, 1319, 1253, 1158, 1094; HRMS (FAB+) calcd for C₁₅H₂₆NO₂SiS: 312.1454, found: 312.1451.

### [Example 9] Preparation of α-Silylamine Compound 9

A solid α-silylamine compound 9 (76.9 mg, 0.247 mmol, 82% yield) was obtained in the same manner as in Example 1, except that trimethylsilylmethyl azide (38.8 mg, 0.30 mmol), a ruthenium catalyst A (6.1 mg, 0.006 mmol), and trans-crotylboronic acid pinacol ester (86.2 mg, 0.45 mmol) were stirred at room temperature for 5 hours under irradiation of a 30 W fluorescent light. R_{f}=0.24 (hexane:EtOAc=90:10). m.p. 142° C.

¹H NMR (300 MHz, CDCl₃): δ=−0.03 (s, 9H), 0.89 (d, J=6.9 Hz, 1H), 2.38-2.50 (m, 4H), 2.87 (dd, J=9.6, 3.6 Hz, 1H), 4.21-4.39 (m, 1H), 4.90-5.08 (m, 2H), 5.62 (ddd, J=17.1, 10.5, 6.9 Hz, 1H), 7.24-7.31 (m, 2H), 7.74 (d, J=8.4 Hz, 2H); ¹³C NMR (75 MHz, CDCl₃): δ=−1.7, 17.9, 21.7, 40.1, 49.7, 115.5, 127.3, 129.7, 138.9, 140.8, 143.2; IR: (cm⁻¹) v 3277, 2961, 1598, 1496, 1321, 1290, 1253, 1094; HRMS (FAB+) calcd for C₁₅H₂₆NO₂SiS: 312.1454, found: 312.1451.

### [Example 10] Preparation of α-Silylamine Compound 10

An α-silylamine compound 10 (47.1 mg, 0.207 mmol, 77% yield) was obtained in the same manner as in Example 3, except that trimethylsilylmethyl azide (34.9 mg, 0.27 mmol), a ruthenium catalyst A (5.4 mg, 0.0054 mmol), and trans-non-2-enyl boronic acid pinacol ester (102.1 mg, 0.405 mmol) were stirred at room temperature for 3 hours under irradiation of a 30 W fluorescent light. R_{f}=0.49 (CH₂Cl₂:MeOH=90:10).

¹H NMR (300 MHz, CDCl₃): δ=0.05 (s, 9H), 0.87 (t, J=6.6 Hz, 3H), 1.18-1.49 (m, 12H), 2.03-2.21 (m, 2H), 4.92-5.12 (m, 2H), 5.63 (dq, J=10.4, 8.7 Hz, 1H); ¹³C NMR (75 MHz, CDCl₃): δ=−2.1, 14.3, 22.9, 27.6, 29.5, 32.1, 32.3, 45.0, 48.0, 116.2, 140.9; IR: (cm⁻¹) v 3370, 2956, 2926, 2856, 1467, 1247, 912; HRMS (ESI+) calcd for C₁₃H₃₀NSi: 228.2142, found: 228.2142.

### [Example 11] Preparation of α-Silylamine Compound 11

An α-silylamine compound 11 (41.4 mg, 0.189 mmol, 76% yield) was obtained in the same manner as in Example 2, except that trimethylsilylmethyl azide (32.3 mg, 0.25 mmol), a ruthenium catalyst A (5.1 mg, 0.005 mmol), and cinnamyl boronic acid pinacol ester (91.6 mg, 0.375 mmol) were stirred at room temperature for 3 hours under irradiation of a 30 W fluorescent light. R_{f}=0.49 (CH₂Cl₂:MeOH=90:10).

¹H NMR (300 MHz, CDCl₃): δ=−0.15 (s, 9H), 1.23 (br s, 2H), 2.49 (d, J=8.7 Hz, 1H), 3.27 (t, J=9.0 Hz, 1H), 5.10-5.25 (m, 2H), 6.01 (dt, J=17.4, 9.6 Hz, 1H), 7.15-7.34 (m, 5H); ¹³C NMR (75 MHz, CDCl₃): δ=−2.7, 45.7, 55.5, 116.5, 126.7, 128.2, 128.8, 140.5, 143.4; IR: (cm⁻¹) v 3371, 3027, 2953, 1688, 1493, 1452, 1247, 992; HRMS (FAB+) calcd for C₁₃H₂₂NSi: 220.1522, found: 220.1524.

### [Example 12] Preparation of α-Silylamine Compound 12

An α-silylamine compound 12 (201.3 mg, 0.190 mmol, 71% yield) was obtained in the same manner as in Example 2, except that trimethylsilylmethyl azide (172.3 mg, 1.33 mmol), a ruthenium catalyst A (27.0 mg, 0.025 mmol), and trans-oct-2-en-4-yl boronic acid pinacol ester (476.4 mg, 2.0 mmol) were stirred at room temperature for 6 hours under irradiation of a 30 W fluorescent light. R_{f}=0.46 (CH₂Cl₂:MeOH=90:10).

¹H NMR (300 MHz, CDCl₃): δ=0.06 (s, 9H), 0.85-0.93 (m, 3H), 0.97 (d, J=6.9 Hz, 3H), 1.23-1.40 (m, 6H), 1.93-2.15 (m, 3H), 2.56 (dquint, J=9.6, 6.9 Hz, 1H), 5.21 (tt, J=10.4, 1.5 Hz, 1H), 5.40 (dt, J=10.8, 7.2 Hz, 1H); ¹³C NMR (75 MHz, CDCl₃): δ=−2.1, 14.2, 19.8, 22.6, 27.6, 32.3, 36.1, 47.0, 130.3, 134.0; IR: (cm⁻¹) v 3447, 2957, 2928, 2859, 1459, 1372, 1247, 836; HRMS (ESI+) calcd for C₁₂H₂₅NSi: 214.1986, found: 214.1986.

### [Example 13] Preparation of α-Silylamine Compound 13

An α-silylamine compound 13 (164.2 mg, 0.748 mmol, 75% yield) was obtained in the same manner as in Example 2, except that dimethylphenylsilylmethyl azide (191.3 mg, 1.0 mmol), a ruthenium catalyst A (20.4 mg, 0.02 mmol), and cis-crotylboronic acid pinacol ester (273 mg, 1.5 mmol) were stirred at room temperature for 3 hours under irradiation of a 30 W fluorescent light. R_{f}=0.30 (CH₂Cl₂:MeOH=90:10).

¹H NMR (300 MHz, CDCl₃): δ=0.37 (s, 3H), 0.37 (s, 3H), 0.94 (d, J=6.9 Hz, 3H), 1.07 (br s, 2H), 2.30-2.41 (m, 1H), 2.43 (d, J=4.2 Hz, 1H), 4.90-5.09 (m, 2H), 5.77 (ddd, J=17.1, 10.5, 6.3 Hz, 1H), 7.34-7.43 (m, 3H), 7.55-7.68 (m, 2H); ¹³C NMR (75 MHz, CDCl₃): δ=−3.9, −3.3, 15.0, 40.7, 45.8, 114.0, 128.0, 129.3, 134.3, 138.2, 143.3; IR: (cm⁻¹) v 3371, 3069, 3050, 2960, 2872, 1821, 1635, 1454, 1374, 1248, 1191, 1060, 988; HRMS (FAB+) calcd for C₁₃H₂₂NSi: 220.1522, found: 220.1524.

### [Example 14] Preparation of α-Silylamine Compound 14

An α-silylamine compound 14 (49.3 mg, 0.225 mmol, 80% yield) was obtained in the same manner as in Example 2, except that dimethylphenylsilylmethyl azide (53.5 mg, 0.28 mmol), a ruthenium catalyst A (5.7 mg, 0.006 mmol), and trans-crotylboronic acid pinacol ester (76.5 mg, 0.42 mmol) were stirred at room temperature for 3 hours under irradiation of a 30 W fluorescent light. R_{f}=0.30 (CH₂Cl₂:MeOH=90:10).

¹H NMR (300 MHz, CDCl₃): δ=0.37 (s, 6H), 1.00 (d, J=6.6 Hz, 3H), 1.24 (br s, 2H), 2.23-2.40 (m, 2H), 4.92-5.09 (m, 2H), 5.61-5.77 (m, 1H), 7.31-7.42 (m, 3H), 7.52-7.61 (m, 2H); ¹³C NMR (75 MHz, CDCl₃): δ=−4.0, −3.5, 18.7, 42.1, 46.1, 115.0, 128.0, 129.2, 134.2, 138.4, 142.3; IR: (cm⁻¹) v 3371, 3069, 2959, 2927, 1637, 1487, 1458, 1248, 1112, 998; HRMS (FAB+) calcd for C₁₃H₂₂NSi: 220.1522, found: 220.1523.

It was confirmed from the above Examples 8 to 14 that the α-silylamine compound was produced in a high yield by a diastereoselective addition reaction between imine having no substituent on nitrogen produced from silyl azide having α-hydrogen and an allylborate compound.

The structures of α-silylazide compound and allylborate compound used in Examples 1 to 14, and α-silylamine compound produced therefrom are shown in the following Table 1:

TABLE 1

| | Reactant | | Product |
|---|---|---|---|
| | α-silylazide | | α-silylamine |
| Example | compound | Allylborate compound | compound |
| 1 | 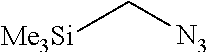 | 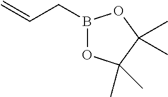 | 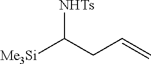 |
| 2 | 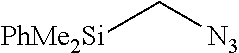 | 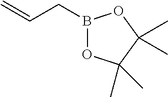 | 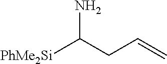 |
| 3 | 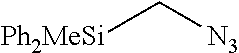 | 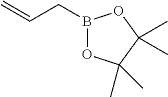 | 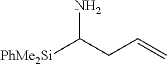 |
| 4 | 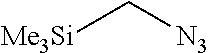 | 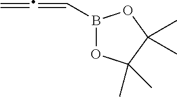 | 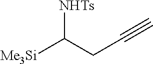 |
| 5 | 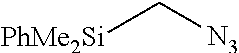 | 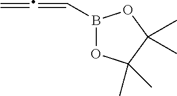 | 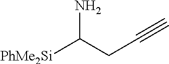 |
| 6 | 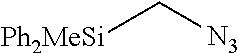 | 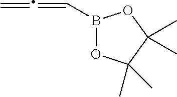 | 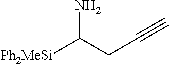 |
| 7 | 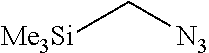 | 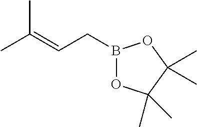 | 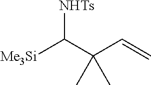 |
| 8 | 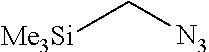 | 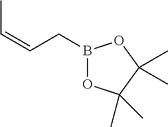 | 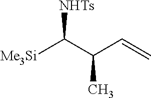 |
| 9 | 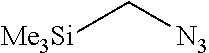 | 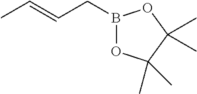 | 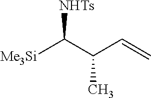 |
| 10 | 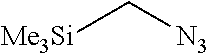 | 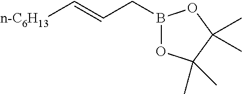 | 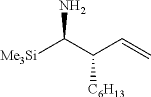 |
| 11 | 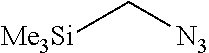 | 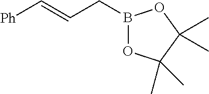 [SMILES: CC1(C)OB(C/C=C/c2ccccc2)OC1(C)C] | 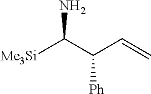 |
| 12 | 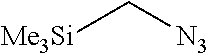 | 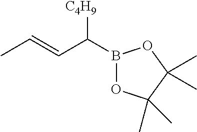 | 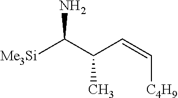 |
| 13 | 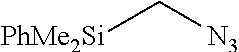 | 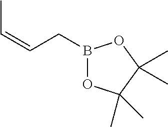 | 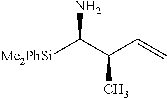 |
| 14 | 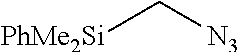 | 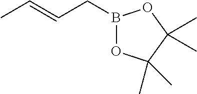 | 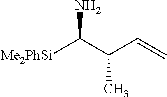 |

### Examples 15 to 20: Asymmetric Addition Reaction Between Imine Having No Substituent on Nitrogen Produced from Silyl Azide Having α-Hydrogen and Allylborate Compound

In the present Examples, a ruthenium complex A was used to as a catalyst, synthesize an α-silylimine intermediate having no substituent on nitrogen from silyl azide having α-hydrogen, and at the same time to carry out an asymmetric addition reaction of an allylborate compound, thereby preparing an α-silylamine compound.

### [Example 15] Preparation of α-Silylamine Compound (R)-15

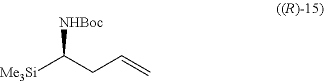 [SMILES: C=CC[C@H](NC(=O)OC(C)(C)C)[Si](C)(C)C]

A ruthenium catalyst A (15.3 mg, 0.015 mmol) was added to THF (0.25 mL) under the nitrogen atmosphere and stirred for 10 minutes to dissolve the ruthenium catalyst A. A solution of trimethylsilylmethyl azide (102.0 mg, 0.75 mmol) and triethyl borane (1M solution in hexane, 0.9 mL, 0.9 mmol) dissolved in THF (0.75 mL) was added to the catalyst solution. The reaction mixture was stirred at room temperature for 1 hour under irradiation of a 30 W fluorescent light, and cooled to −78° C. (-)-Ipc₂B(allyl) borane (1M solution, 1.13 mL, 1.13 mmol) and THF (0.75 mL) were mixed, and cooled to −78° C. The reaction mixture was transferred to the side where the borane solution is present, using a double-ended needle, while maintaining the temperature at −78° C., and then stirred at −78° C. for 10 hours, and chloroform (1 mL) was added thereto, thereby finishing the reaction. Then, the reactant was transferred to a separatory funnel, and then acidified with 1N HCl until the pH was 1, and an aqueous layer was separated therefrom. Then, the aqueous layer was neutralized with 6 N NaOH at 0° C. until the pH was 10. The aqueous layer was extracted with diethyl ether (5×5 mL), and then water was removed by Na₂SO₄ from the collected organic layer, which was concentrated under a reduced pressure condition after filtration.

The concentrated solution was dissolved in dichloromethane (CH₂Cl₂, 15 mL, 0.05 M) without a further purification process, and then di-tert-butyl dicarbonate (Boc₂O, 246 mg, 1.13 mmol) was added thereto. The reaction mixture was stirred at room temperature for 18 hours, water (10 mL) was added thereto to finish the reaction, and dichloromethane (3×10 mL) was added thereto for extraction. Water was removed by Na₂SO₄ from collected organic layer, which was then concentrated under a reduced pressure condition after filtration. Purification with column chromatography using silica gel (3 cm×13 cm, eluent—hexane: diethyl ether=90:10) gave an α-silylamine compound (R)-15 (109.9 mg, 0.452 mmol, 60% yield). Enantiomeric excess value was measured by (R)-16. R_{f}=0.28 (hexane:Ether=90:10).

¹H NMR (300 MHz, CDCl₃): δ=0.04 (s, 9H), 1.41 (s, 9H), 1.90-2.13 (m, 1H), 2.25-2.38 (m, 1H), 3.00-3.27 (m, 1H), 3.95-4.31 (m, 1H), 4.95-5.08 (m, 1H), 5.79 (ddt, J=16.8, 9.9, 6.9 Hz, 1H); ¹³C NMR (75 MHz, CDCl₃): δ=−3.0, 28.6, 36.3, 40.5, 79.0, 116.6, 136.7, 156.4; IR: (cm⁻¹) v 3448, 3343, 2978, 2931, 2900, 1700, 1640, 1498, 1366, 1250, 1174; HRMS (FAB+) calcd for C₁₂H₂₆NO₂Si: 244.1727, found: 244.1725. [α]_{D}²⁰ +28.3 (c 1.2, CHCl₃).

### [Example 16] Preparation of α-Silylamine Compound (R)-16

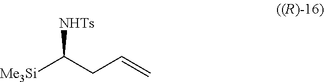

A ruthenium catalyst A (15.3 mg, 0.015 mmol) was added to THF (0.25 mL) under the nitrogen atmosphere and stirred for 10 minutes to dissolve the ruthenium catalyst A. A solution of trimethylsilylmethyl azide (102.0 mg, 0.75 mmol) and triethyl borane (1M solution in hexane, 0.9 mL, 0.9 mmol) dissolved in THF (0.75 mL) was added to the catalyst solution. The reaction mixture was stirred at room temperature for 1 hour under irradiation of a 30 W fluorescent light, and cooled to −78° C. (-)-Ipc₂B(allyl) borane (1M solution, 1.13 mL, 1.13 mmol) and THF (0.75 mL) were mixed, and cooled to −78° C. The reaction mixture was transferred to the side where the borane solution is present, using a double-ended needle, while maintaining the temperature at −78° C., and then stirred at −78° C. for 10 hours, and chloroform (1 mL) was added thereto, thereby finishing the reaction. Then, the reactant was transferred to a separatory funnel, and then acidified with 1N HCl until the pH was 1, and an aqueous layer was separated therefrom. Then, the aqueous layer was neutralized with 6 N NaOH at 0° C. until the pH was 10. The aqueous layer was extracted with diethyl ether (5×5 mL), and then water was removed by Na₂SO₄ from the collected organic layer, which was concentrated under a reduced pressure condition after filtration.

An N-para-toluene sulfonyl substituted α-silylamine compound (R)-16 (41% yield) was prepared by the method of Example 1, using para-toluene sulfonyl chloride without a further purification process of the concentrated solution.

Enantiomeric excess (87%) of was determined by HPLC on a Chiralcel OD column (hexane:2-propanol=98:2; flow rate=1.0 mL/min; UV=254 nm); retention time=15.3 min (R), 18.8 m in (S); [α]_{D}²⁰ +8.9 (c 0.81, CHCl₃).

### [Example 17] Preparation of α-Silylamine Compound (R)-17

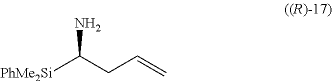

A ruthenium catalyst A (5.1 mg, 0.005 mmol) was added to THF (0.25 mL) under the nitrogen atmosphere and stirred for 10 minutes to dissolve the ruthenium catalyst A. A solution of dimethylphenylsilylmethyl azide (47.8 mg, 0.25 mmol) and triethyl borane (1M solution in THF, 0.30 mL, 0.30 mmol) dissolved in THF (0.25 mL) was added to the catalyst solution. The reaction mixture was stirred at room temperature for 1 hour under irradiation of a 30 W fluorescent light, and then cooled to −78° C. (-)-Ipc₂B(allyl) borane (1M solution, 0.38 mL, 0.38 mmol) and THF (1.6 mL) were mixed, and cooled to −78° C. The reaction mixture was transferred to the side where the borane solution is present, using a double-ended needle, while maintaining the temperature at −78° C., and then stirred at −78° C. for 10 hours, and chloroform (1 mL) was added thereto, thereby finishing the reaction. Then, the reactant was transferred to a separatory funnel, and then acidified with 1N HCl until the pH was 1, and an aqueous layer was separated therefrom. Then, the aqueous layer was neutralized with 6 N NaOH at 0° C. until the pH was 10. The aqueous layer was extracted with diethyl ether (5×5 mL), and then water was removed by Na₂SO₄ from the collected organic layer, which was concentrated under a reduced pressure condition after filtration. Purification with preparative TLC (PTLC, 10 cm×15 cm, eluent—hexane: isopropylamine=95:5) gave an α-silylamine compound (R)-17 (31.8 mg, 0.155 mmol, 62% yield). R_{f}=0.34 (CH₂Cl₂:MeOH=90:10). [α]_{D}²² +11.6 (c 0.43, CHCl₃).

### [Example 18] Preparation of α-Silylamine Compound (R)-18

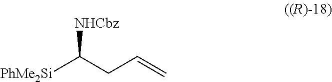

To a solution of α-silylamine compound (R)-17 (28.7 mg, 0.14 mmol) and triethylamine (39 μL, 0.28 mmol) dissolved in THF (0.7 mL, 0.2 M), benzylchloroformate (21 μL, 0.21 mmol) was added. The reaction mixture was stirred at room temperature for 5 hours, water (3 mL) was added thereto to finish the reaction, and then dichloromethane (3×3 mL) was added thereto for extraction. Water was removed by Na₂SO₄ from collected organic layer, which was then concentrated under a reduced pressure condition after filtration. Purification with column chromatography using silica gel (3 cm×15 cm, eluent—hexane:ethyl acetate=90:10) gave an α-silylamine compound (R)-18 (34.0 mg, 0.10 mmol, 72% yield). R_{f}=0.38 (hexane:EtOAc=90:10).

¹H NMR (300 MHz, CDCl₃): δ=0.36 (s, 6H), 2.04 (dt, J=14.4, 8.1 Hz, 1H), 2.36-2.51 (m, 1H), 3.49 (td, J=10.2, 4.2 Hz, 1H), 4.43 (d, J=10.2 Hz, 1H), 4.92-5.13 (m, 4H), 5.63-5.88 (m, 1H), 7.30-7.42 (m, 8H), 7.50-7.59 (m, 2H); ¹³C NMR (75 MHz, CDCl₃): δ=−4.7, −4.3, 36.4, 40.9, 66.8, 117.0, 128.2, 128.2, 128.7, 129.8, 134.2, 136.2, 156.9; IR: (cm⁻¹) v 3424, 3330, 3069, 3033, 2960, 1954, 1882, 1816, 1699, 1505, 1428, 1375, 1250, 1113, 1059; HRMS (ESI+) calcd for C₂₀H₂₅NO₂SiNa: 362.1547, found: 362.1546.

### [Example 19] Preparation of α-Silylamine Compound (R)-19

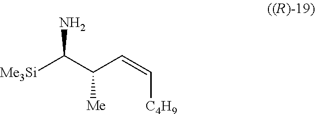

An α-silylamine compound (R)-19 (170.7 mg, 0.80 mmol, 80% yield) was obtained in the same manner as in Example 2, except that trimethylsilylmethyl azide (129.2 mg, 1.00 mmol), a ruthenium catalyst A (20.4 mg, 0.020 mmol), and (R)-trans-oct-2-en-4-yl boronic acid pinacol ester (357.3 mg, 1.5 mmol) were stirred at room temperature for 6 hours under irradiation of a 30 W fluorescent light. R_{f}=0.46 (CH₂Cl₂:MeOH=90:10). Enantiomeric excess was measured by (R)-20. [α]_{D}²⁰ +30.0 (c 0.50, CHCl₃).

### [Example 20] Preparation of α-Silylamine Compound (R)-20

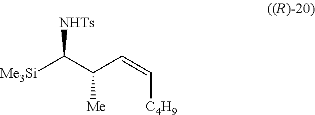

An N-para-toluene sulfonyl substituted α-silylamine compound (R)-20 (140.7 mg, 0.383 mmol, 83% yield) was obtained in the same manner as in Example 1, using the α-silylamine compound (R)-19 and para-toluene sulfonyl chloride. R_{f}=0.45 (hexane:EtOAc=90:10). m.p. 108° C.

¹H NMR (500 MHz, CDCl₃): δ=0.11 (s, 9H), 0.98 (d, J=6.5 Hz, 3H), 2.41 (s, 3H), 2.50-2.62 (m, 1H), 3.20-3.32 (m, 1H), 3.62 (dd, J=16.0, 6.5 Hz, 1H), 3.99 (dd, J=16.0, 6.5 Hz, 1H), 4.63 (d, J=10.5 Hz, 1H), 4.76 (d, J=17.0 Hz, 1H), 5.07-5.21 (m, 2H), 5.39 (ddd, J=17.0, 10.0, 8.4 Hz, 1H), 5.91 (ddd, J=17.0, 10.0, 6.5 Hz, 1H), 7.25 (d, J=8.0 Hz, 2H), 7.68 (d, J=8.0 Hz, 2H); ¹³C NMR (75 MHz, CDCl₃): δ=0.1, 19.7, 21.7, 39.9, 51.5, 57.0, 114.1, 115.6, 127.8, 129.4, 136.4, 139.1, 142.8, 144.1; IR: (cm⁻¹) v 3428, 2957, 2929, 1645, 1320, 1253, 1160, 1095, 1015, 837; HRMS (ESI+) calcd for C₁₉H₃₃NO₂SSiNa: 390.1893, found: 390.1891.

Enantiomeric excess (89%) was determined by HPLC on a Chiralcel ID column (hexane:2-propanol=98:2; flow rate=0.6 mL/min; UV=254 nm); retention time=25.7 min (R), 27.6 min (S); [α]_{D}²⁰ +30.0 (c 0.37, CHCl₃).

It was confirmed from the above Examples 15 to 20 that the α-silylamine compound was produced in a high yield by an asymmetric addition reaction between imine having no substituent on nitrogen produced from silyl azide having α-hydrogen and an allylborate compound.

### [Example 21] Preparation I of Azacyclic Compound 34 from α-Silylamine Compound

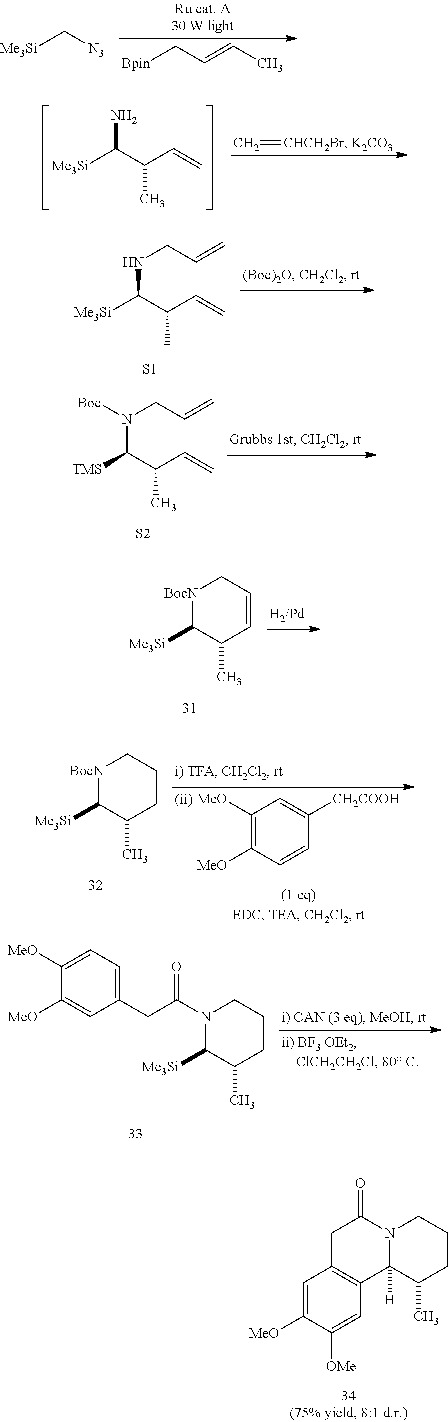

Preparation of Compound 31

i) Preparation of Intermediate S1

A ruthenium catalyst A (61.1 mg, 0.060 mmol) was added to THF (4.0 mL) under the nitrogen atmosphere and stirred for 10 minutes to dissolve the ruthenium catalyst A. A solution of trimethylsilylmethyl azide (517 mg, 4.0 mmol) and trans-crotylboronic acid pinacol ester (1.09 g, 6.0 mmol) dissolved in THF (4.0 mL) was added to the catalyst solution. The reaction mixture was stirred at room temperature for 3 hours under irradiation of a 30 W fluorescent light. When the stirring is completed, chloroform (3 mL) was added thereto to finish the reaction, and the stirring was performed for another 5 minutes. Then, the reactant was transferred to a separatory funnel, and acidified with 1N HCl until the pH was 1, and an aqueous layer was separated therefrom. Then, the aqueous layer was neutralized with 6 N NaOH at 0° C. until the pH was 10. The aqueous layer was extracted with diethyl ether (5×10 mL), and then water was removed by Na₂SO₄ from the collected organic layer, which was concentrated under a reduced pressure condition after filtration.

The concentrated solution was directly dissolved in dimethyl formamide (DMF, 16 mL, 0.25 M) without a further purification process. To this solution, allyl bromide (0.38 mL, 4.4 mmol) and potassium carbonate (K₂CO₃, 1.1 g, 8.0 mmol) were added. The reactant was stirred at room temperature for 12 hours, and the reaction was finished by adding 10 mL of water. Then, the reactant was transferred to a separatory funnel, an organic layer and an aqueous layer were separated, and then the aqueous layer was extracted by dichloromethane (3×10 mL). Water was removed by Na₂SO₄ from the collected organic layer, which was concentrated under a reduced pressure condition after filtration. Purification with column chromatography using silica gel (3 cm×13 cm, eluent—hexane:ethyl acetate=80:20) gave a compound S1 (609 mg, 3.09 mmol, 77% yield). R_{f}=0.62 (hexane:EtOAc=80:20).

¹H NMR (300 MHz, CDCl₃): δ=0.05 (s, 9H), 1.06 (d, J=6.8 Hz, 3H), 1.68-1.80 (m, 2H), 2.28-2.43 (m, 4H), 2.69 (dt, J=13.2, 2.9 Hz, 1H), 3.50-3.58 (m, 1H), 5.08-5.19 (m, 2H), 5.56-5.73 (m, 2H), 5.83-6.01 (m, 1H), 7.24 (d, J=8.1 Hz, 2H), 7.69 (d, J=8.1 Hz, 2H); ¹³C NMR (75 MHz, CDCl₃): δ=−1.0, 18.6, 40.0, 53.2, 53.4, 113.9, 115.8, 137.8, 143.5; IR: (cm⁻¹) v 3449, 3078, 2960, 2929, 1736, 1642, 1454, 1418, 1373, 1248, 1099, 996; HRMS (ESI+) calcd for C₁₁H₂₄NSi: 198.1673, found: 198.1672.

ii) Preparation of Intermediate S2

Compound S1 (600 mg, 3.04 mmol) was dissolved in dichloromethane (CH₂Cl₂, 32 mL, 0.05 M), and then di-tert-butyl dicarbonate (Boc₂O, 1.09 g, 5.01 mmol) was added thereto. The reaction mixture was stirred at room temperature for 18 hours, water (30 mL) was added thereto to finish the reaction, and dichloromethane (3×30 mL) was added thereto for extraction. Water was removed by Na₂SO₄ from collected organic layer, which was then concentrated under a reduced pressure condition after filtration. Purification with column chromatography using silica gel (3 cm×13 cm, eluent—hexane:EtOAc=90:10) gave a compound S2 (817 mg, 2.75 mmol, 90% yield). R_{f}=0.75 (hexane:EtOAc=90:10).

¹H NMR (300 MHz, CDCl₃): δ=0.08 (s, 9H), 0.98 (d, J=6.6 Hz, 3H), 1.41 (s, 9H), 2.26-2.48 (m, 1H), 2.80-2.97 (m, 1H), 3.34 (dd, J=15.2, 7.4 Hz, 0.7H), 3.44-3.60 (m, 0.3H), 3.98 (dd, J=15.0, 5.9 Hz, 0.7H), 4.05-4.13 (m, 0.3H), 4.86-5.21 (m, 4H), 5.64 (ddd, J=17.1, 10.2, 8.9 Hz, 1H), 5.71-5.88 (m, 1H); ¹³C NMR (75 MHz, CDCl₃): δ=0.1, 19.1, 28.9, 38.8, 56.3, 78.9, 113.9, 116.6, 135.8, 144.0, 155.4; IR: (cm⁻¹) v 3079, 2979, 2934, 2903, 1813, 1759, 1688, 1640, 1457, 1248, 1120; HRMS (ESI+) calcd for C₁₆H₃₁NO₂SSiNa: 320.2016, found: 320.2021.

iii) Preparation of Compound 31

Compound S2 (803 mg, 2.7 mmol) and a Grubbs catalyst (1^{st} generation, 44.4 mg, 5.4 mmol) were dissolved in dichloromethane (54 mL, 0.05 M), and stirred at room temperature for 12 hours. The reaction mixture was concentrated under a condition of reduced pressure. Purification with column chromatography using silica gel (3 cm×13 cm, eluent—hexane:EtOAc=90:10) gave a compound 31 (551 mg, 2.04 mmol, 76% yield). R_{f}=0.53 (hexane:EtOAc=90:10).

¹H NMR (300 MHz, CDCl₃): δ=0.01 (s, 9H), 0.98-1.10 (m, 3H), 1.45 (s, 9H), 2.32-2.48 (m, 1H), 3.39-3.70 (m, 2H), 4.10-4.39 (m, 1H), 5.45-5.59 (m, 1H), 5.70-5.73 (m, 1H); ¹³C NMR (75 MHz, CDCl₃): δ=−1.9, −1.8, 21.7, 21.8, 28.7, 30.5, 30.7, 42.1, 43.0, 47.1, 48.7, 79.2, 79.3, 122.8, 123.4, 130.5, 131.1, 155.7, 155.9; IR: (cm⁻¹) v 3079, 2979, 2934, 2903, 1813, 1688, 1640, 1457, 1372, 1248, 1120, 1073; HRMS (ESI+) calcd for C₁₄H₂₇NO₂SSiNa: 292.1703, found: 292.1703.

Preparation of Compound 32

Compound 31 (500 mg, 1.86 mmol) and Pd/C (22.4 mg) were dissolved in methanol (18.6 mL, 0.1 M), and stirred at room temperature for 6 hours under the hydrogen atmosphere. The reaction mixture was concentrated under a condition of reduced pressure after filtration. Purification with column chromatography using silica gel (3 cm×15 cm, eluent—hexane:ethyl acetate=90:10) have a compound 32 (393 mg, 1.45 mmol, 78% yield). R_{f}=0.59 (hexane:EtOAc=90:10).

¹H NMR (300 MHz, CDCl₃): Rotamer A: δ=0.07 (s, 9H), 1.03 (d, J=6.9 Hz, 3H), 1.43 (s, 9H), 1.53-1.76 (m, 4H), 1.95-2.06 (m, 1H), 2.59 (td, J=12.7, 3.0 Hz, 1H), 3.38-3.47 (m, 1H), 4.21 (d, J=11.4 Hz, 1H); Rotamer B: δ=0.07 (s, 7.2H), 1.03 (d, J=6.9 Hz, 2.4H), 1.43 (s, 7.2H), 1.53-1.76 (m, 3.2H), 1.95-2.06 (m, 0.8H), 2.74-2.85 (m, 0.8H), 3.38-3.47 (m, 0.8H), 3.88 (d, J=12.8 Hz, 0.8H); ¹³C NMR (75 MHz, CDCl₃): δ=−1.5, 21.7, 22.4, 41.3, 42.4, 117.9, 124.9, 125.9, 127.1, 129.8, 134.9, 138.6, 143.1; IR: (cm⁻¹) v 2977, 2934, 1699, 1423, 1253, 1166, 941; HRMS (ESI+) calcd for C₁₄H₂₉NO₂SSiNa: 294.1860, found: 294.1860.

Preparation of Amide Compound 33

Compound 32 (370 mg, 1.36 mmol) was dissolved in dichloromethane (CH₂Cl₂, 19.4 mL, 0.07 M) and then trifluoroacetic acid (2.1 mL, 27.2 mmol) was added dropwise thereto. The temperature was slowly raised to room temperature, and then stirring was performed for 2 hours. 20 mL of water was added to finish the reaction, and then 6 N NaOH was added to neutralize the reactant. The solution was transferred to a separatory funnel, and then an organic layer and an aqueous layer were separated. The aqueous layer was extracted with diethyl ether (3×20 mL), and then water was removed by Na₂SO₄ from the collected organic layer, which was concentrated under a reduced pressure condition after filtration. The concentrated solution was dissolved in dichloromethane (CH₂Cl₂, 27.2 mL, 0.05 M) without a further purification process, and then EDC HCl (391.1 mg, 1.94 mmol) and triethylamine (0.26 mL, 1.84 mmol), 3,4-dimethoxyphenyl acetic acid (266.8 mg, 1.36 mmol) were added thereto at 0° C. The reaction mixture was stirred at room temperature for 24 hours, sat. NH₄Cl (25 mL) was added thereto to finish the reaction, and then diethyl ether (3×25 mL) was added thereto for extraction. Water was removed by Na₂SO₄ from the collected organic layer, which was then concentrated under a reduced pressure condition after filtration. Purification with column chromatography using silica gel (3 cm×12 cm, eluent—hexane:ethyl acetate=60:40) gave a compound 33 (353 mg, 1.01 mmol, 74% yield). R_{f}=0.44 (hexane:EtOAc=60:40).

¹H NMR (300 MHz, CDCl₃): Rotamer A: δ=0.08 (s, 9H), 0.99 (d, J=7.2 Hz, 3H), 1.13-1.44 (m, 1H), 1.45-1.68 (m, 3H), 1.76-1.96 (m, 1H), 2.78-2.96 (m, 1H), 3.66 (br s, 2H), 3.73-3.82 (m, 1H), 3.85 (s, 6H), 4.37 (d, J=5.4 Hz, 1H), 6.70-6.87 (m, 3H); Rotamer B: δ=0.08 (s, 2.7H), 0.88 (d, J=6.9 Hz, 0.9H), 1.13-1.44 (m, 0.3H), 1.45-1.68 (m, 0.9H), 1.76-1.96 (m, 0.3H), 2.27-2.41 (m, 0.3H), 3.62 (br s, 0.6H), 3.73-3.82 (m, 0.3H), 3.85 (s, 1.8H), 4.67 (dd, J=13.2, 2.1 Hz, 0.3H), 6.70-6.87 (m, 0.9H); ¹³C NMR (150 MHz, CDCl₃): δ=−0.9, −0.8, 19.8, 20.1, 20.3, 21.7, 28.2, 29.1, 29.2, 40.4, 40.9, 41.0, 45.7, 49.7, 53.4, 55.9, 56.0, 56.1, 111.7, 111.8, 112.1, 112.9, 128.6, 148.0, 149.4, 169.5, 170.1; IR: (cm⁻¹) v 2953, 2870, 2835, 1626, 1590, 1515, 1451, 1261, 1237, 1190, 1153, 1030; HRMS (ESI+) calcd for C₁₉H₃₁NO₃SiNa: 372.1965, found: 372.1959.

Preparation of Azacyclic Compound 34

A flask including ceric ammonium nitrate (164.5 mg, 0.30 mmol) was filled with nitrogen gas, and the amide compound 33 (35.0 mg, 0.10 mmol) was dissolved in MeOH (4.0 mL, 0.025M), which is then transferred to ceric ammonium nitrate. After stirring at room temperature for 12 hours, dichloromethane (5 mL) was added thereto. Then, this solution was washed with sat. NaCl (3×5 mL). Water was removed by Na₂SO₄ from collected organic layer, which was concentrated under a reduced pressure condition after filtration. The solution remaining after concentration was transferred to a seal tube, which was then filled with nitrogen, and the solution was dissolved in 1,2-dichloroethane (ClCH₂CH₂Cl, 4.0 mL, 0.025 M), and BF₃OTf₂ (50 μL, 0.40 mmol) was added dropwise thereto. The reaction mixture was stirred at 80° C. for 24 hours, and then water (5 mL) was added thereto to finish the reaction. Dichloromethane (3×5 mL) was added to perform extraction from the reaction mixture, and water was removed by Na₂SO₄ from the collected organic layer, which was concentrated under a reduced pressure condition after filtration. Purification with column chromatography using silica gel (3 cm×15 cm, eluent—CH₂Cl₂:MeOH=95:5) gave an azacyclic compound 34 (20.8 mg, 0.0754 mmol, 75% yield). (R_{f}=0.82 (CH₂Cl₂:MeOH=90:10).

¹H NMR (300 MHz, CDCl₃): major isomer, Rotamer A δ=0.92 (d, J=6.6 Hz, 3H), 1.21-1.59 (m, 5H), 1.63-1.84 (m, 2H), 1.94 (d, J=11.7 Hz, 1H), 2.58-2.71 (m, 1H), 3.43-3.67 (m, 2H), 3.86 (s, 6H), 4.76 (d, J=12.6 Hz, 1H), 6.59 (s, 2H); major isomer, Rotamer B δ=0.92 (d, J=6.6 Hz, 0.6H), 1.21-1.59 (m, 1H), 1.63-1.84 (m, 0.4H), 1.94 (d, J=11.7 Hz, 0.2H), 2.18-2.29 (m, 0.2H), 3.43-3.67 (m, 0.4H), 3.86 (s, 1.2H), 4.90 (d, J=11.1 Hz, 1H), 6.59 (s, 0.4H); minor isomer δ=0.65 (d, J=6.9 Hz, 0.45H), 1.21-1.59 (m, 0.75H), 1.63-1.84 (m, 0.3H), 2.02 (d, J=5.7 Hz, 0.15H), 2.58-2.71 (m, 0.15H), 3.43-3.67 (m, 0.3H), 3.91 (s, 0.9H), 4.56 (br s, 0.15H), 6.52 (s, 0.3H); ¹³C NMR (75 MHz, CDCl₃): major isomer δ=19.6, 25.8, 34.8, 36.1, 38.9, 45.2, 56.1, 56.3, 68.2, 110.3, 111.2, 123.9, 124.7, 147.0, 148.8, 168.6; minor isomer δ=111.1, 14.3, 22.5, 31.5, 37.0, 43.9, 56.3, 107.8, 109.6, 125.1, 148.5, 148.8; IR: (cm⁻¹) v 2925, 2854, 1741, 1649, 1561, 1518, 1460, 1377, 1252, 1119; HRMS (ESI+) calcd for C₁₆H₂₁NO₃Na: 298.1414, found: 298.1415.

### [Example 22] Preparation II of Azacyclic Compound 36 from α-Silylamine Compound

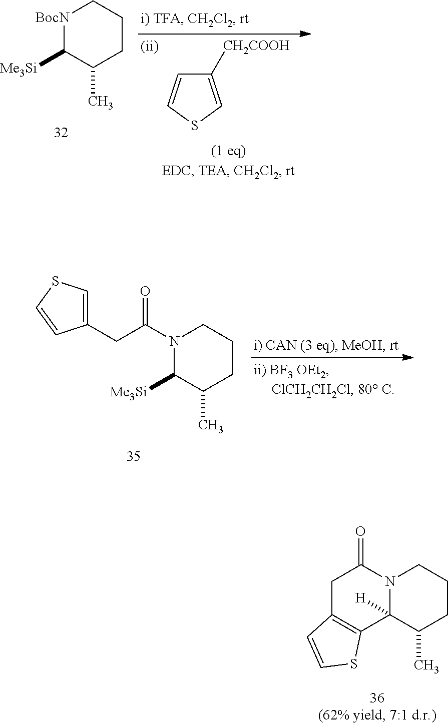

Preparation of Amide Compound 35

Compound 32 (135.7 mg, 0.500 mmol) was dissolved in dichloromethane (CH₂Cl₂, 7.1 mL, 0.07 M), and then trifluoroacetic acid (0.77 mL, 10.0 mmol) was added dropwise thereto. The temperature was slowly raised to room temperature, and then stirring was performed for 2 hours. 10 mL of water was added to finish the reaction, and then 6 N NaOH was added to neutralize the reactant. The solution was transferred to a separatory funnel, and then an organic layer and an aqueous layer were separated. The aqueous layer was extracted with diethyl ether (3×10 mL), and then water was removed by Na₂SO₄ from the collected organic layer, which was concentrated under a reduced pressure condition after filtration. The concentrated solution was dissolved in dichloromethane (CH₂Cl₂, 10.0 mL, 0.05 M) without a further purification process, and then EDC HCl (143.8 mg, 0.75 mmol), triethylamine (94 μL, 0.135 mmol) and thiophene 3-acetic acid (71 mg, 0.500 mmol) were added thereto at 0° C. The reaction mixture was stirred at room temperature for 24 hours, sat. NH₄Cl (10 mL) was added thereto to finish the reaction, and then diethyl ether (3×10 mL) was added thereto for extraction. Water was removed by Na₂SO₄ from the collected organic layer, which was then concentrated under a reduced pressure condition after filtration. Purification with column chromatography using silica gel (3 cm×13 cm, eluent—hexane:ethyl acetate=40:60) gave a compound 35 (93.1 mg, 0.315 mmol, 63% yield). R_{f}=0.83 (hexane:EtOAc=40:60).

¹H NMR (300 MHz, CDCl₃): Rotamer A: δ=0.05 (s, 9H), 0.98 (d, J=6.9 Hz, 1H), 1.23-1.52 (m, 3H), 1.58-1.82 (m, 1H), 1.94-2.10 (m, 1H), 2.99 (ddd, J=13.5, 11.1, 3.0 Hz, 1H), 3.63-3.80 (m, 3H), 3.96 (br s, 1H), 6.92-7.15 (m, 2H), 7.25-7.33 (m, 1H); Rotamer B: δ=0.06 (s, 2.7H), 0.87 (d, J=6.9 Hz, 0.9H), 1.23-1.52 (m, 0.9H), 1.58-1.82 (m, 0.3H), 1.94-2.10 (m, 0.3H), 2.41 (td, J=12.9, 2.7 Hz, 0.3H), 3.63-3.80 (m, 0.6H), 4.70 (dt, J=13.2, 1.9 Hz, 0.3H), 6.92-7.15 (m, 0.6H), 7.25-7.33 (m, 0.3H); ¹³C NMR (75 MHz, CDCl₃): Rotamer A: δ=−0.6, 20.3, 21.8, 29.2, 29.2, 36.5, 46.1, 49.7, 121.8, 125.9, 135.9, 169.2; Rotamer B: δ=−0.7, 19.8, 20.4, 28.3, 25.8, 41.1, 53.6, 122.4, 125.9, 135.7, 169.8; IR: (cm⁻¹) v 2952, 2870, 1627, 1447, 1431, 1301, 1249, 1133, 830; HRMS (ESI+) calcd for C₁₅H₂₅NOSSiNa: 318.1318, found: 318.1318.

Preparation of Amide Compound 36

An azacyclic compound 36 (13.8 mg, 0.062 mmol, 62% yield) was obtained in the same manner as the preparation process of the azacyclic compound 34 of Example 21, except that the amide compound 35 (29.5 mg, 0.10 mmol) and ceric ammonium nitrate (164.5 mg, 0.30 mmol) were stirred at room temperature for 18 hours.

¹H NMR (300 MHz, CDCl₃): major isomer δ=1.11 (d, J=6.3 Hz, 3H), 1.33-1.78 (m, 5H), 1.88-2.01 (m, 1H), 2.58 (td, J=12.5, 3.5 Hz, 1H), 3.48-3.69 (m, 2H), 4.15 (d, J=10.2 Hz, 1H), 4.83-4.99 (m, 1H), 6.79 (d, J=5.1 Hz, 1H), 7.23 (d, J=5.1 Hz, 1H); minor isomer δ=0.69 (d, J=6.9 Hz, 0.48H), 1.33-1.78 (m, 0.80H), 1.88-2.01 (m, 0.16H), 2.52-2.68 (m, 0.16H), 3.48-3.69 (m, 0.32H), 4.76-4.82 (m, 0.16H), 6.74 (d, J=4.8 Hz, 0.16H), 7.23 (d, J=5.1 Hz, 0.16H); ¹³C NMR (75 MHz, CDCl₃): δ=19.6, 25.7, 33.2, 34.7, 39.9, 44.9, 65.0, 125.2, 126.0, 130.6, 132.2, 167.1; IR: (cm⁻¹) v 2925, 2853, 1640, 1463, 1436, 1412, 1378 1259, 1169, 1131; HRMS (ESI+) calcd for C₁₂H₁₆NOS: 222.0947, found: 222.0947.

### INDUSTRIAL APPLICABILITY

The method of preparing an α-silylamine compound of the present invention may produce various α-silylamine compounds from an α-silylmethyl azide compound via a nitrogen-unsubstituted α-silylimine intermediate through a reaction with various allylboronate compounds under a mild condition in the presence of a metal complex catalyst.

In addition, in the preparation method of the present invention, an α-silylamine compound having functional groups and multiple stereocenters including high diastereoselectivity and enantioselectivity, and a geometry of double bond, which was not able to be produced in the past, may be prepared by a one-pot reaction, through an addition reaction of an allyl nucleophile of an allylboronate compound.

In addition, the α-silylamine compound prepared by the preparation method of the present invention may be used in iminium ion-mediated oxidative cyclization under an oxidant condition such as ceric ammonium nitrate (CAN) by utilizing a silyl group.

1. A method of preparing an α-silylamine compound of the following Chemical Formula 1 comprising: photoreacting an α-silylmethyl azide compound of the following Chemical Formula 2 with a boronate compound of the following Chemical Formula 3 in the presence of a metal complex catalyst: 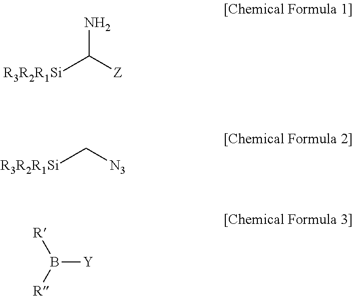
wherein R₁, R₂ and R₃ are independently of each other (C1-C20)alkyl;
when R′ and R″ are linked by 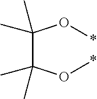 [SMILES: *OC(C)(C)C(C)(C)O*]
to form a ring, Y is 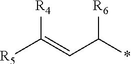
and Z is 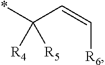
or Y is 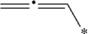 [SMILES: *C=C=C]
and Z is 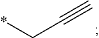 [SMILES: *CC#C]
when R′ and R″ are 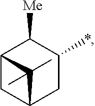
Y is 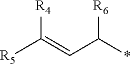
and Z is 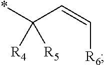
and
R₄, R₅ and R₆ are independently of each other hydrogen, (C1-C20)alkyl or (C6-C20)aryl.

2. The method of claim 1, wherein the α-silylmethyl azide compound of the following Chemical Formula 2 is photoreacted with an allylboronate compound of the following Chemical Formula 3-a in the presence of a metal complex catalyst, to prepare an α-silylamine compound of the following Chemical Formula 1-a: 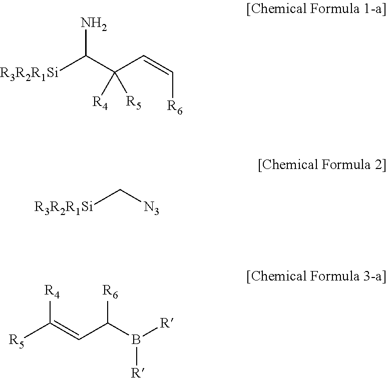
wherein R₁, R₂ and R₃ are independently of each other (C1-C20)alkyl;
R′ and R″ are 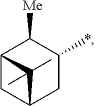
or R′ and R″ are linked by 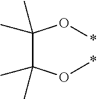 [SMILES: *OC(C)(C)C(C)(C)O*]
to form a ring; and
R₄, R₅ and R₆ are independently of each other hydrogen, (C1-C20)alkyl or (C6-C20)aryl.

3. The method of claim 1, wherein the α-silylmethyl azide compound of the following Chemical Formula 2 is photoreacted with an allenylboronate compound of the following Chemical Formula 3-b in the presence of a metal complex catalyst, to prepare an α-silylamine compound of the following Chemical Formula 1-b: 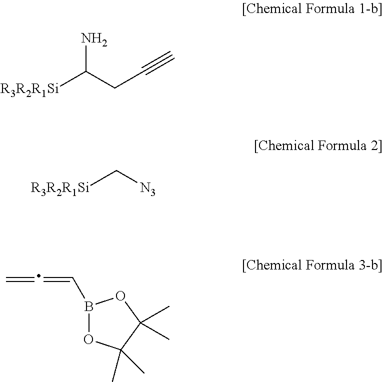
wherein R₁, R₂ and R₃ are independently of each other (C1-C20)alkyl.

4. The method of claim 1, wherein the metal complex catalyst is a ruthenium complex catalyst.

5. The method of claim 4, wherein the ruthenium complex catalyst is represented by the following structure: 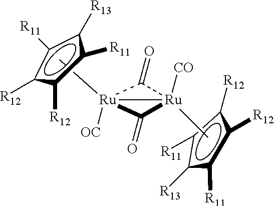
wherein R₁₁ and R₁₂ are independently of each other hydrogen, (C1-C20)alkyl or (C6-C20)aryl;
R₁₃ is NR₁₄R₁₅, OR₁₆, C(═O)NR₁₇R₁₈ or C(═O)OR₁₉; and
R₁₄ to R₁₉ are independently of each other hydrogen, (C1-C20)alkyl or (C6-C20)aryl.

6. The method of claim 5, wherein the ruthenium complex catalyst is represented by the following structure:

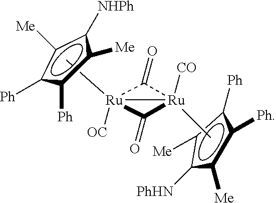

7. The method of claim 1, wherein the photoreaction is carried out under irradiation of visible light.

8. The method of claim 1, wherein the boronate compound of Chemical Formula 3 is selected from the group consisting of boronate compounds represented by the following Chemical Formulae 4 to 6: 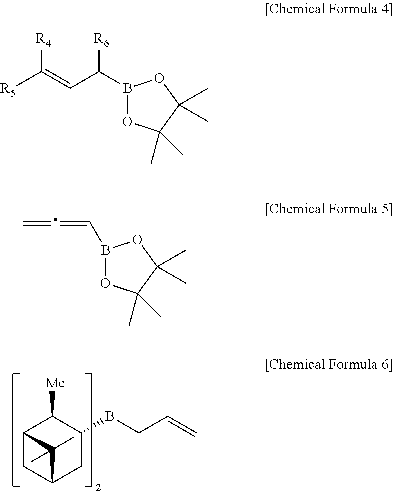
wherein R₄, R₅ and R₆ are independently of each other hydrogen, (C1-C20)alkyl or (C6-C20)aryl.

9. The method of claim 8, wherein when the boronate compound of Chemical Formula 4 or 5 is used, reaction temperature is room temperature to 50° C.

10. The method of claim 8, wherein when the boronate compound of Chemical Formula 6 is used, tri(C1-C10)alkyl borane is further added.

11. The method of claim 10, wherein a mixture of the silylmethyl azide compound of Chemical Formula 2 and tri(C1-C10)alkyl borane is irradiated with visible light at room temperature to 50° C. in the presence of the ruthenium catalyst, and then the boronate compound of Chemical Formula 6 is added thereto at −78° C. to room temperature.
